(19) United States
(12) Patent Application Publication
(10) Pub. No.: US 2016/0361853 A1
(43) Pub. Date: Dec. 15, 2016

(54) METHOD AND APPARATUS FOR APPLYING AN INJECTION MOULDED PART TO A FINISHED PRODUCTION PART

(71) Applicant: Exco Technologies Limited dba Neocon, Dartmouth (CA)

(72) Inventors: Vance Philip BUCHANAN, Hammonds Plains (CA); Christopher Francis TARRANT, Shubenacadie East (CA)

(21) Appl. No.: 15/182,783

(22) Filed: Jun. 15, 2016

Related U.S. Application Data
(60) Provisional application No. 62/175,515, filed on Jun. 15, 2015.

(51) Int. Cl. B29C 45/14; B29C 45/72; B29C 45/80; B29C 45/04; B29C 45/66; B29C 45/16; B29C 45/40

(52) U.S. Cl. CPC B29C 45/14336; B29C 45/1671; B29C 45/14065; B29C 45/72; B29C 45/40; B29C 45/0416; B29C 45/66; B29C 45/80; B29L 2031/30

(57) ABSTRACT

The disclosure is directed at a method and apparatus for locally applying an injection moulded part to a primary part. The apparatus includes an injection moulding tool which includes a top and bottom mould which, when closed around the primary part, define a cavity into which resin can be injected. The cavity defined by the top and bottom moulds is smaller than a footprint of the primary part. In other words, the top and bottom moulds have a footprint which is less than a footprint of the primary part.

### CROSS-REFERENCE TO OTHER APPLICATIONS

This application claims the benefit of U.S. Patent Application No. 62/175,515, filed Jun. 15, 2015, which is incorporated herein by reference.

### FIELD OF THE DISCLOSURE

The disclosure is directed generally at injection moulding and more specifically at a method and apparatus for locally applying an injection moulded part to a primary part.

### BACKGROUND OF THE DISCLOSURE

Injection moulding is a process that has been around for many years. The process involves the injection of a material into a mould for the production of a discrete item. In the automobile industry, injection moulding has been used to manufacture individual vehicle parts.

In order for manufacturers to identify their vehicle parts, manufacturers usually include an identifying mark, such as a logo, on a surface of the part which is visible to the naked eye. These logos are typically mounted to the surface of the vehicle part. As the logo portions are simply attached to the surface of the part, they may become easily dislodged or fall off.

There is provided a novel method and apparatus for applying an injection moulding part to a production part.

### SUMMARY OF THE DISCLOSURE

In one aspect of the disclosure, there is provided a method for locally applying an injection moulded part to a primary part including placing the primary part atop a bottom mould and then sandwiching the primary part between the bottom mould and a top mould. The top and bottom mould define a cavity within a footprint of the primary part. Resin is then injected into the cavity to locally apply the injection moulded part to the primary part. In another aspect, the method further includes cooling the resin; and removing the finished production part.

In another aspect of the disclosure, multiple coloured resins can be injected into the cavity. This may be accomplished by injecting a first coloured resin into a first resin receiving hole and then injecting a second coloured resin into a second resin receiving hole.

In another aspect, a footprint of the top mould is smaller than the footprint of the primary part. In yet another aspect, a footprint of the bottom mould is smaller than the footprint of the primary part.

In yet a further aspect of the disclosure, there is provided apparatus for locally applying an injection moulded part to a primary part including a support structure, a resin injector mounted to the frame for injecting resin and an injection moulding tool. The injection moulding tool includes a top mould and a bottom mould and an opening for receiving the resin from the resin injector. The apparatus further includes a set of support arms, the support arms connected to the support structure in a hinged relationship for moving the top mould with respect to the bottom mould. The top mould and bottom mould define a cavity within a footprint of the primary part when the top mould and bottom mould sandwich the primary part. The resin injector injects resin into the cavity to locally apply the injection moulded part with the primary part.

In another aspect, the apparatus includes an intermediate tool for distributing resin from the resin injector to the injection moulding tool. The intermediate tool may include a resin receiving hole and a set of resin distribution holes corresponding to resin receiving holes within the top mould of the injection moulding tool. A set of channels for directing resin from the resin receiving hole to the set of resin distribution holes are also located within the intermediate tool.

### DESCRIPTION OF THE DRAWINGS

Embodiments of the present disclosure will now be described, by way of example only, with reference to the attached Figures.

FIG. 1a is a schematic view of one embodiment of how a logo is currently affixed to a production part;

FIG. 1b is a schematic view of another embodiment of how a logo is currently affixed to a production part;

FIG. 2a is a schematic diagram of apparatus in accordance with the disclosure in an open position;

FIG. 2b is a schematic diagram of apparatus in accordance with the disclosure in a closed position;

FIG. 2c is a photograph of another embodiment of apparatus in accordance with the disclosure in a closed position;

FIG. 3a is a perspective view of an injection moulding tool;

FIGS. 3b to 3d are schematic diagrams of a bottom mould of the injection moulding tool;

FIG. 4 is a flowchart outlining a method of integrating an injection moulded part with a finished production part;

FIG. 5a is a front perspective view of an integrated injection moulded part with a finished production part in accordance with the current disclosure;

FIG. 5b is a rear perspective view of an integrated injection moulded part with a finished production part in accordance with the current disclosure;

FIGS. 5c and 5d are photographs of further embodiments of an integrated injection moulded part with a finished production part;

FIGS. 6a and 6b are perspective view of an intermediate tool and a mould;

FIG. 6c is a perspective view of another embodiment of the intermediate tool;

FIG. 6d is a perspective view of a further embodiment of the intermediate tool; and

FIG. 6e is a perspective view of the intermediate tool with multiple resin reservoirs.

### DETAILED DESCRIPTION OF THE DISCLOSURE

The disclosure is directed at a method and apparatus for integrating, or locally applying, an injection moulded part with a primary part, such as a finished production part. In one embodiment of the disclosure, the method and apparatus of the disclosure allows for an identification portion, such as a logo or design to be integrated with or applied to the finished production part. The injection moulded part is locally applied to the finished production part.

In another embodiment, the identification portion may be multi-coloured which is applied or integrated to the finished production part in one-pass process.

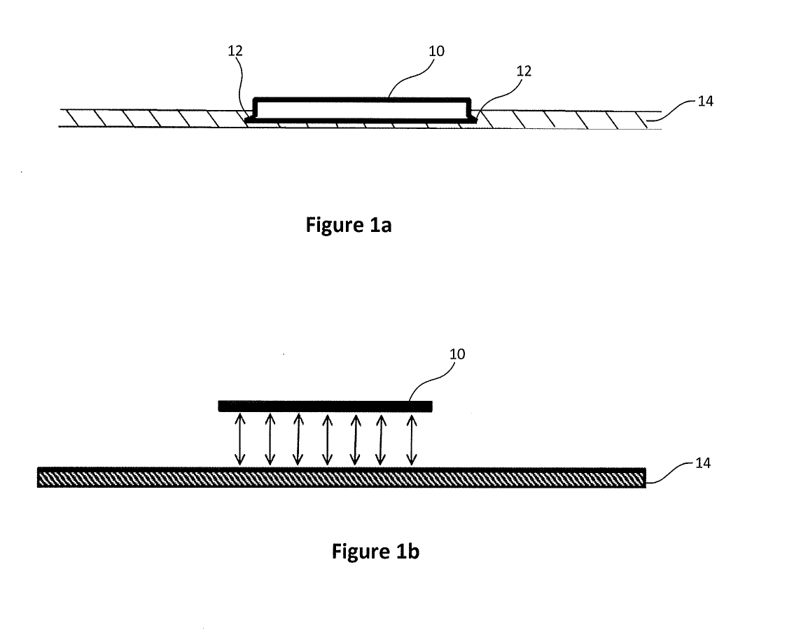

Turning to FIG. 1a, a first example of how a logo portion is currently affixed to a finished production part is shown. In the example of FIG. 1a, a top logo or design portion 10 is shown. The logo portion 10, which is preferably manufactured via an injection moulding process, includes a set of ridges 12.

When the production part 14 is manufactured, such as via an injection moulded process, the production part 14 is designed with an area or space for receiving the logo portion 10. After the logo portion is inserted or mated into an injection moulding tool, the logo portion may be mechanically encapsulated by the production part via the injection moulding process of the production part 14. In this manner, the logo portion is fitted within the space.

Turning to FIG. 1b, another schematic example of how a logo portion is currently affixed to a finished production part is shown. In this embodiment, the logo portion 10 is adhered directly to a surface of the finished production part 14. An adhesive bonding layer is used to attach the logo portion 10 to part 14. However, this may not be a secure solution. For instance, the adhesion properties of the adhesive layer may lose its strength or a force may be applied to the logo portion 10 to dislodge it from the surface of the production part 14. In this manner, identification of the production part becomes more difficult after the logo portion has been dislodged or removed.

The current disclosure provides a method and apparatus of integrating or locally applying an injection moulded part to a finished production part. One advantage of the current disclosure is that the method and apparatus provide for the localized integration of the injection moulded part, such as an identification portion, with the finished production part. Another advantage of an embodiment of the current disclosure is that since the identification portion is integrated with the finished production part, there is a less likelihood of separation of the identification portion from the finished production part. The identification portion would have to be purposefully separated from the production part in order for separation to occur.

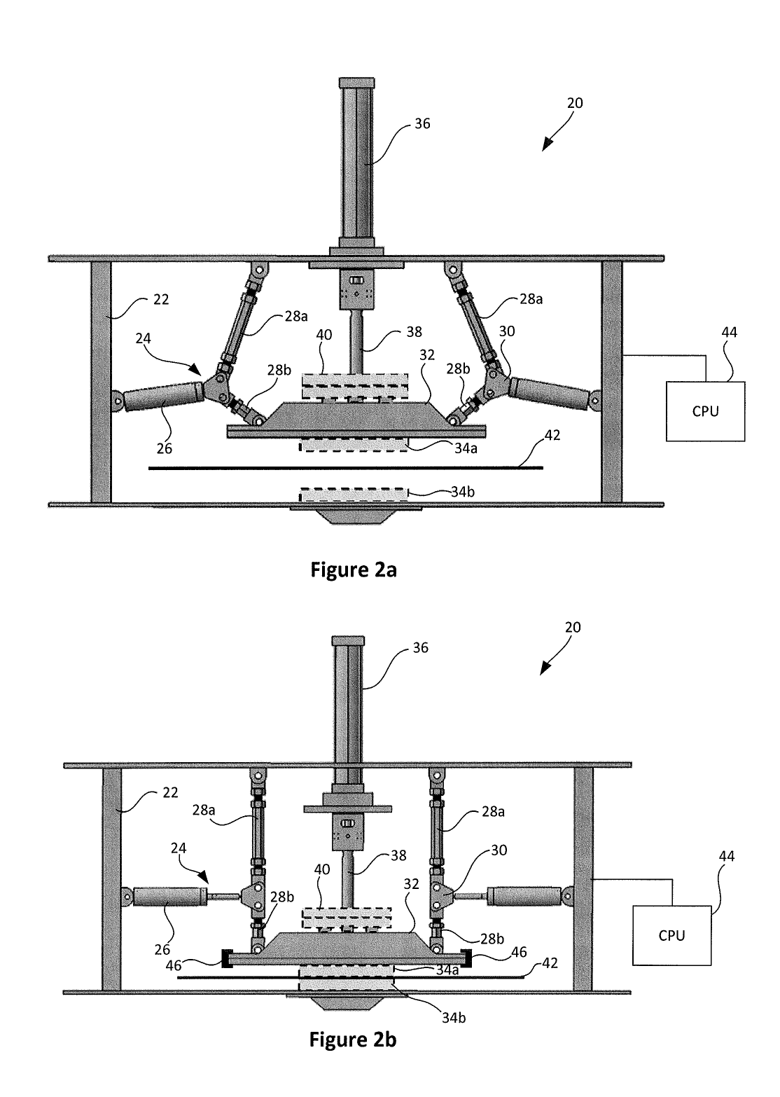

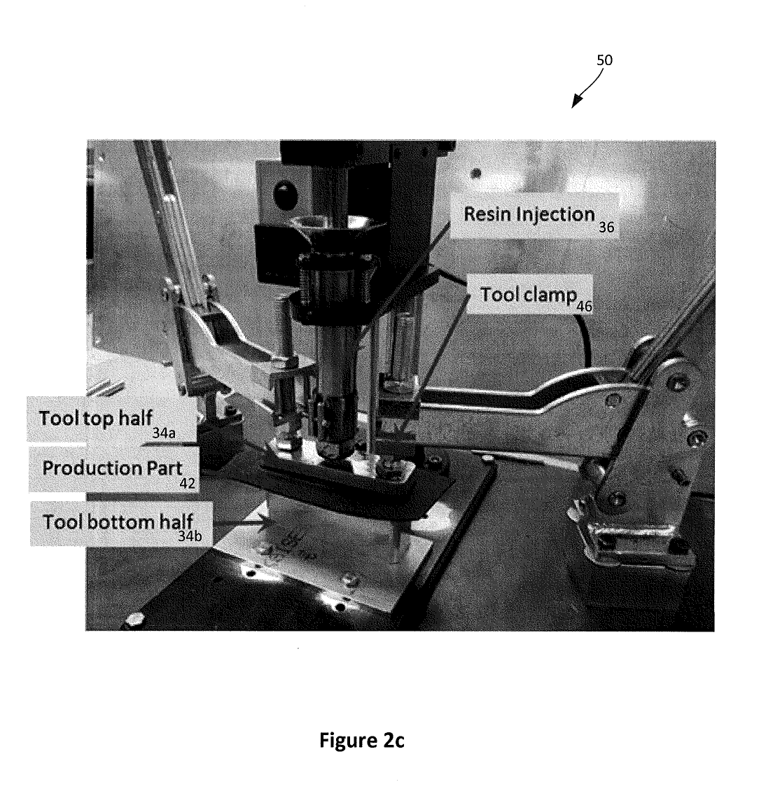

Turning to FIGS. 2a and 2b, schematic diagrams of a first embodiment of an apparatus for integrating an injection moulded part with a finished production part are shown. FIG. 2a provides a view of the apparatus in an open position while FIG. 2b provides a view of the apparatus in a closed position.

The apparatus 20 includes a frame, or support structure, 22 supporting a set of support arms 24 extending from the frame 22. Each of the support arms 24 includes a base portion 26 and a pair of dynamic arms 28 which are in a pivoting, or hinged, relationship with the base portion 26 via a connector 30 which may be seen as a pivotable connector. The connector 30 allows for the dynamic arms to pivot with respect to the connector 30. One end of the base portion 26 is mounted to the frame 22 while a second end of the base portion 26 is connected to the connector 30. In the current embodiment, the base portion 26 is mounted to the frame 22 in a pivoting or hinged relationship.

One of the dynamic arms 28a has a first end connected to the connector 30 and a second end to the frame 22. The connection between the dynamic arm 28a and the frame 22 is preferably in a pivoting or hinged relationship. The other of the dynamic arms 28b is connected at one end to the connector 30 and at a second end to a tool mounting plate 32. The connection between the dynamic arm 28b and the tool mounting plate 32 is preferably via a pivoting or hinged relationship. The support arms 24 provide the mechanism for moving the tool mounting plate 32 from the open position to the closed position and vice versa.

In the current embodiment, the tool mounting plate 32 houses, or is connected to, a top mould 34a. The top mould 34a and a bottom mould 34b may be seen as an injection moulding tool 34. Although listed as top and bottom moulds, if the moulds are in a horizontal plane, the moulds may be seen as a left mould and a right mould.

The apparatus 20 further includes a resin injector 36 that is preferably a multi-colour resin injector but can also be a single colour resin injector. The resin injector 36 is connected via tubing, or piping, 38 through an intermediate tool 40, the tool mounting plate 32 and the top mould 34a to inject resin into a cavity which is created by the top 34a and bottom 34b moulds of the injection moulding tool 34 around a finished production part 42, or a primary part, when the apparatus 20 is in the closed position (as shown in FIG. 2b). The injection of the resin assists in the local application of an injection moulded part to the final production part 42.

The finished production part 42 may be formed by any type of method or material. For instance, the finished production part 42 may be injection moulded. The finished production part 42 may also be made of wood or other materials such as, but not limited to, aluminium, steel, and composite laminates.

The set of support arms 24 control a position of the top mould 34a. In the current embodiment, the support arms 24 are in a hinged relationship with the frame 22 allowing the arms 24 to move the top mould 34a in a vertical direction. The apparatus 20 may also be set up such that the support arms 24 can move the top mould 34a horizontally with respect to the frame 22. A central processing unit (CPU) 44 controls movement of the support arms 24 based on input provided to the CPU 44.

Prior to the positioning or movement of the top mould 34a, the finished production part 42 is positioned, and preferably aligned, atop, or with, the bottom mould 34b. For instance, the bottom mould 34b may include protrusions which mate with alignment holes within the production part 42.

As shown in FIG. 2b, to reach the closed position from the open position, the support arms 24 move to urge, or lower, the top mould 34a towards the bottom mould 34b until the top mould 34a comes in contact with the production part 42 and sandwiches the production part 42 between itself and the bottom mould 34b. Unlike some current systems, in the current system, the top 34a and bottom 34b moulds do not need to fully encapsulate the final production part 42 in order for the identification portion to be integrated with or locally applied to the part 42. Movement of the support arms 24 also causes the resin injection 36 to move in a similar, or identical, direction as controlled by the CPU 44.

After the top mould 34a is brought into contact with the production part 42 (seen as the closed position), a further tool, such as a clamping tool or clamp 46, may be used to hold, or secure, the top 34a and bottom 34b moulds in place against the production part 42. In some embodiments, the clamp 46 may not be necessary. Once the apparatus 20 is in the closed position, the integration, or local application, of the identification portion may be performed by injecting resin via the resin injector 36. This will be described in more detail below.

Turning to FIG. 2c, a perspective view of another embodiment of apparatus for integrating an injection moulded part with a finished production part is shown. In the current embodiment, the apparatus 50 is in the closed position. The apparatus 50 includes the injection moulding tool 34 including the top mould 34a and the bottom mould 34b in contact with the finished production part 42. The apparatus 50 further includes the resin injection apparatus 36 along with the clamp 46. As can be seen, the top mould 34a and the bottom mould 34b abut, or sandwich, the production part 42 but they do not encapsulate the entire production part 42 unlike current systems. In other words, the footprint of the top and bottom moulds is less than a footprint of the production part.

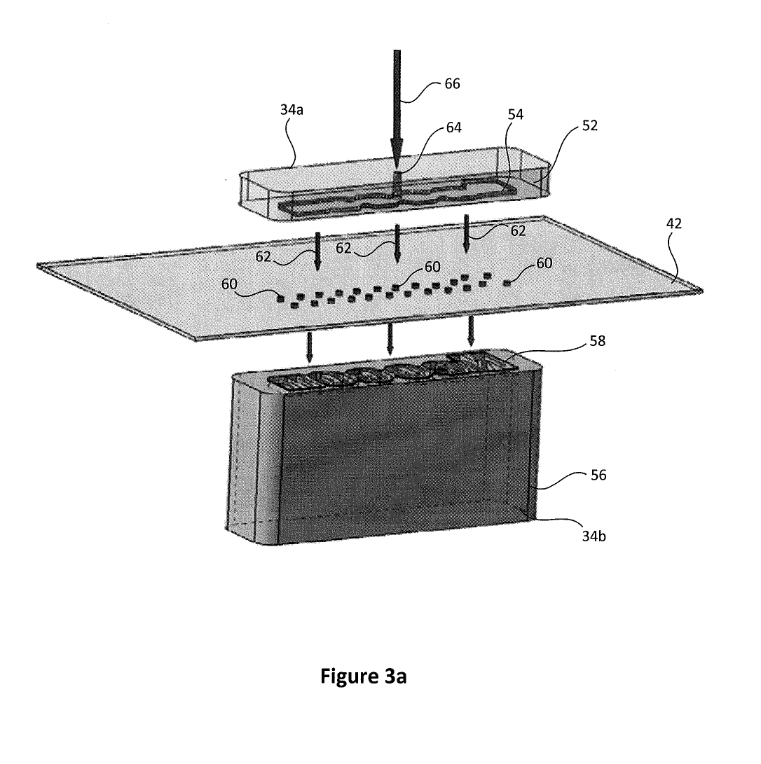

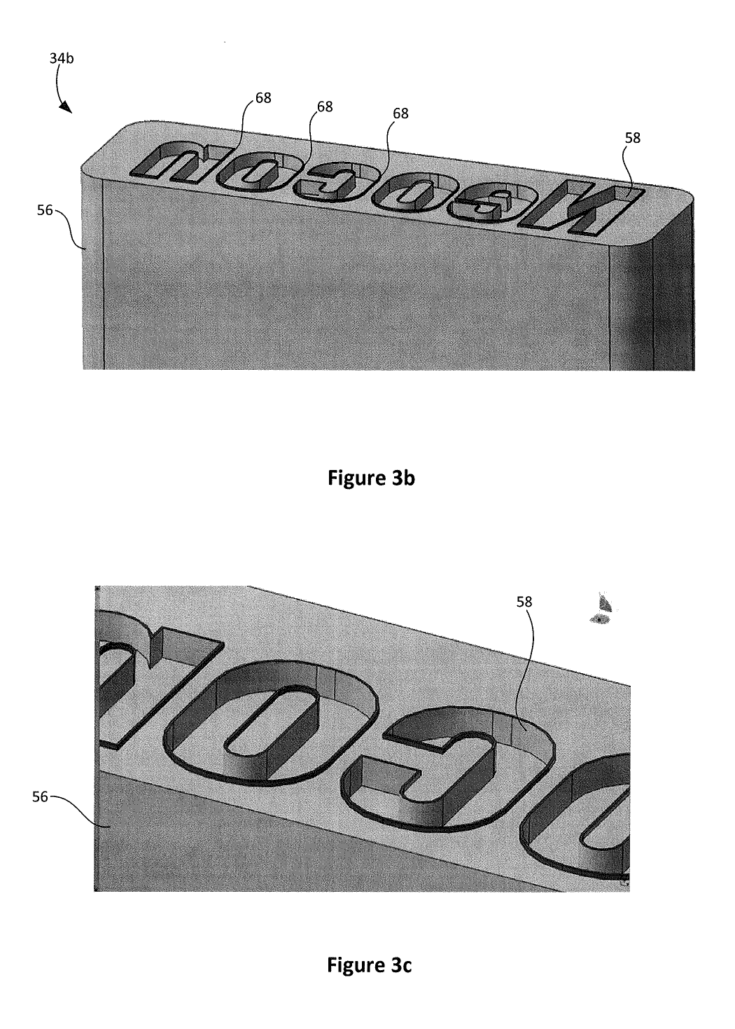

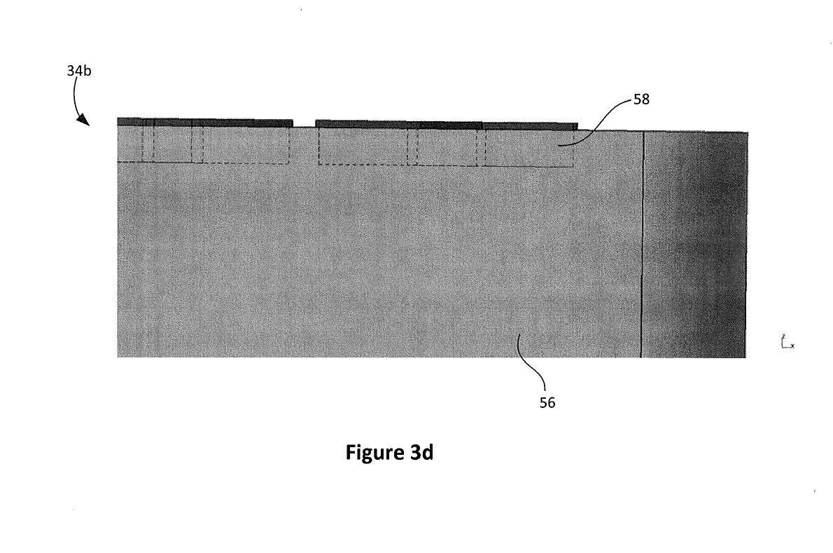

Turning to FIG. 3a, a perspective view of the injection moulding tool and a finished production part is shown. The top mould 34a includes a top body portion 52 along with a design portion which can be seen as a rear geometry portion 54. The rear geometry portion 54 provides an area for receiving the injected resin. The bottom mould 34b includes a bottom body portion 56 along with its own design portion which may be seen as a front geometry portion 58. The rear 54 and front 58 geometry portions form a cavity within which the injected resin is received to locally apply the injection moulded part to the final production part 42. In the closed position, the top mould 34a and the bottom mould 34b sandwich the primary part 42 whereby the cavity is defined within a footprint of the primary part. The production part 42 includes a set of holes 60 which are used to allow the resin to pass through the production part 42 into the front geometry portion 58. The holes 60 may be thermoformed into the production part 42 or added via a die cut step. The holes 60 may also be used to align the production part 42 with the bottom mould 34b.

In the current embodiment, arrows 62 reflect the direction that the top mould 34a travels to move from the open position to the closed position such that the production part 42 is captured between the two moulds 34a and 34b. In the current embodiment, the resin is injected via an opening or connector 64 into the top mould 34a in the direction of arrow 66.

Turning to FIGS. 3b to 3d, further schematic diagrams of the bottom mould 34b are shown. As shown in FIG. 3b, the front geometry portion 58 includes a lip portion 68 which assists to enhance a seal between the final production part 42 and the bottom mould 34b when in the closed position. The lip portion 68 may be seen as a protruding perimeter wall around each letter of the front geometry portion 58. The lip portion 68 compresses into the production part 42 when the top 34a and bottom 34b moulds are closed around the production part 42 to ensure or provide a seal around each feature (or letter) of the design portion, thereby preventing or reducing the amount of resin from leaking outside the intended area of the production part 42. In order words, the lip portion 68 reduces any bleeding of the resin into an unwanted area or areas within the surface of the production part 42. Although not shown, the rear geometry portion also preferably includes a lip portion to enhance a seal between the top mould 34a and the final production part 42.

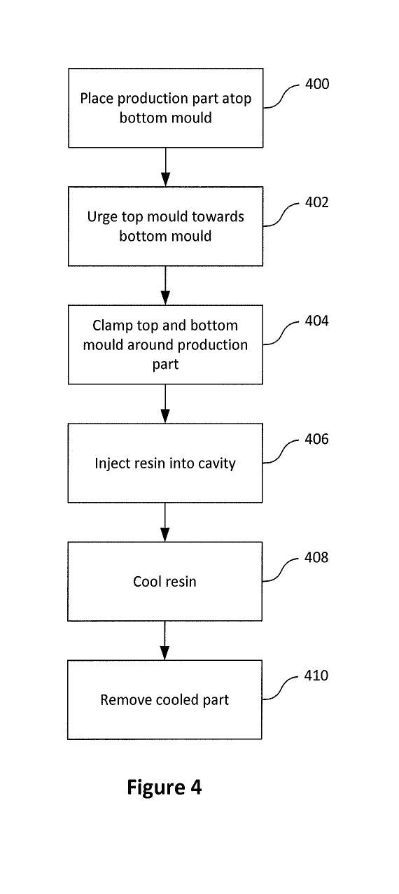

Turning to FIG. 4, a flowchart outlining a method of locally applying an injection moulded part to a finished production part is shown. In a preferred embodiment, the injection moulded part is an identification portion. Initially, the finished production part, or primary part, 42 is placed (400) atop the bottom mould 34b. This may be performed in an automated manner or a user may manually place the production part atop the bottom mould. If the process is automated, machinery may align the production part 42 with the bottom mould 34b. In one embodiment, this may be achieved by using the holes 60 within the production part 42. In another embodiment, a location jig may be used to properly locate the production part 42 within the injection moulding apparatus 20 such that the area where the injection moulded part is to be located on the surface of the production part 42 is between the two moulds 34a and 34b.

The top mould 34a is then urged (402) towards the bottom mould 34b until it comes in contact with the production part 42, thereby sandwiching the production part 42 between the two moulds. A cavity (or cavities) is then created by the two moulds and the production part. A clamping tool may then be used to clamp (404) the top and bottom moulds around the production part with a footprint of the moulds being less than a footprint of the production part.

Resin is then injected (406) into the cavity which is formed by the injection moulding tool 34. In other words, resin is injected to fill the space defined by the front and rear geometry portions and the production part. As the resin is being injected and being received by the top mould, the resin preferably passes through the holes in the production part to fill the bottom mould (or front geometry portion). In one embodiment, the injection of resin may include multiple colours (as will be discussed below).

After the resin has been injected, the resin is cooled (408). After the resin has cooled, the top mould 34a is urged away from the production part 42 by the support arms 24 so that the finished production part (with the locally applied injection moulded part) can be removed (410). The cooled resin forms the identification portion that is integrated with the production part 42 leaving a designed geometry on one surface of the production part 42 while also providing built-in fastening on the other opposite surface.

In another embodiment, the bottom mould 34a may be a flat surface wherein resin is only injected into a cavity defined by the top mould 34a and the production part 42. In this manner, the cooled resin (or identification portion) may be seen as being attached, applied, or integrated, with the production part.

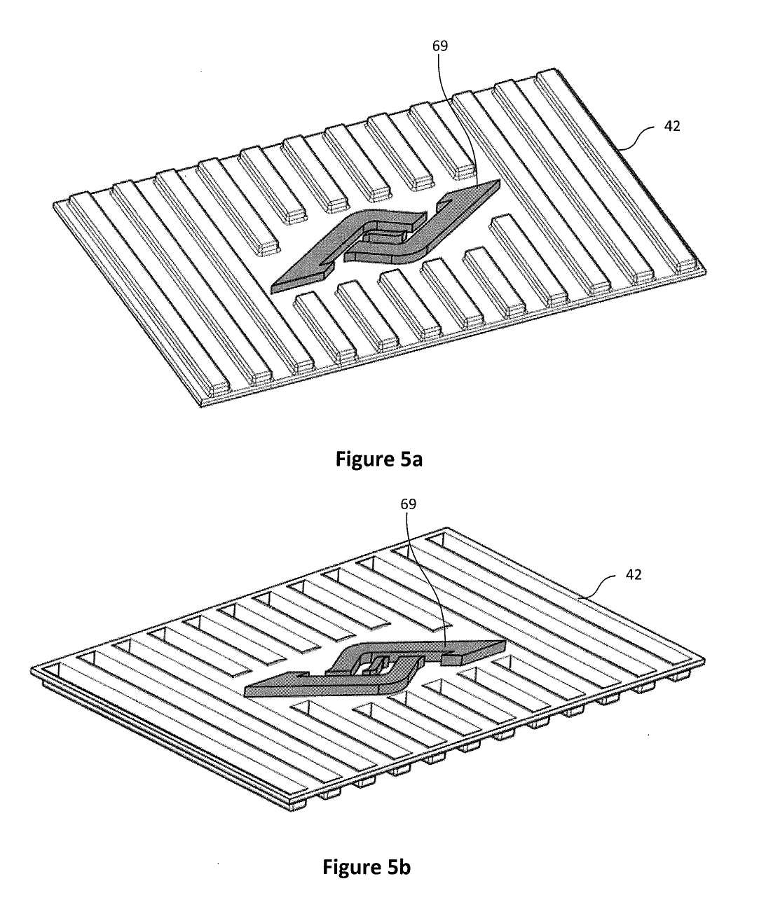

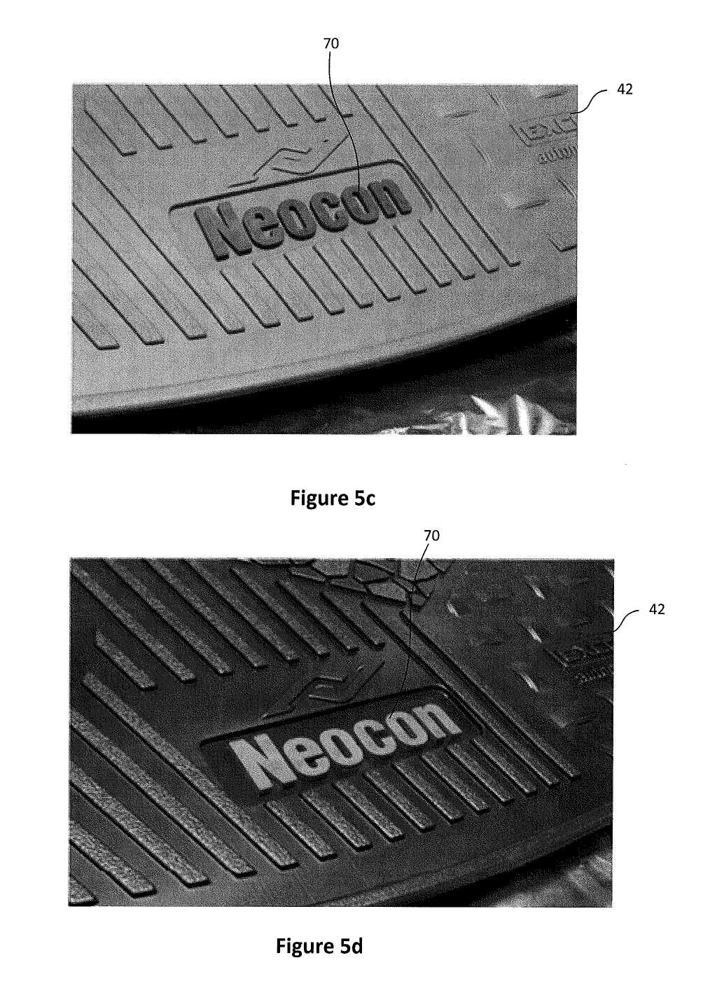

Turning to FIGS. 5a to 5d, various embodiments of a finished production part with an integrated, or locally applied, injection moulded part are shown. FIG. 5a is a front perspective of a finished production part 42 with an injection moulding part 69 while FIG. 5b is a rear perspective view of the finished production part of FIG. 5a. FIGS. 5c and 5d provide front perspective views of other production parts with injection moulding parts locally applied.

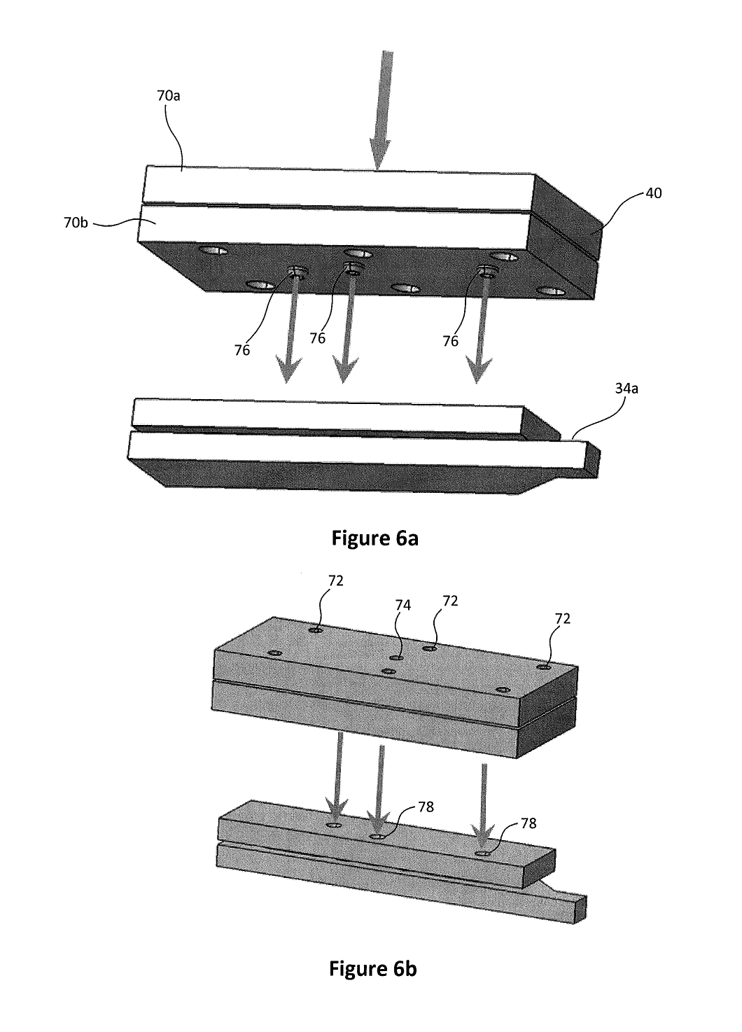

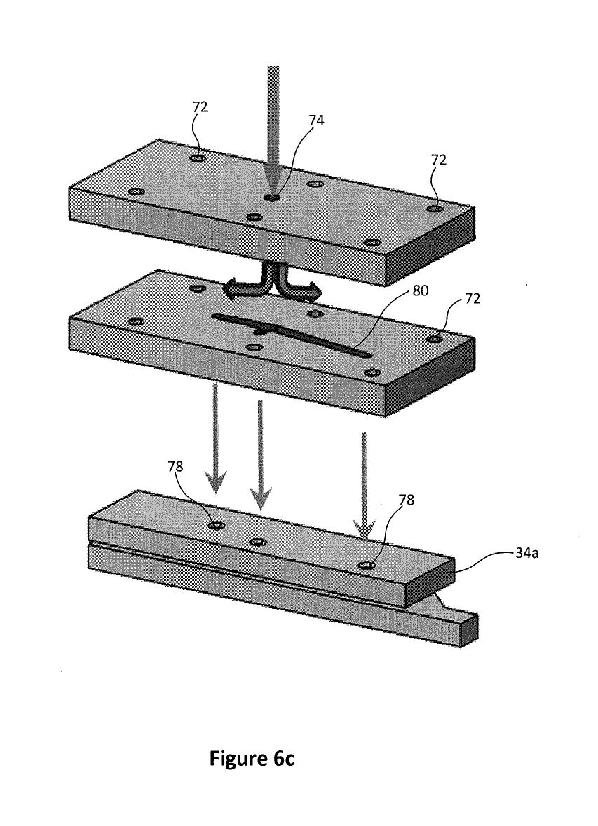

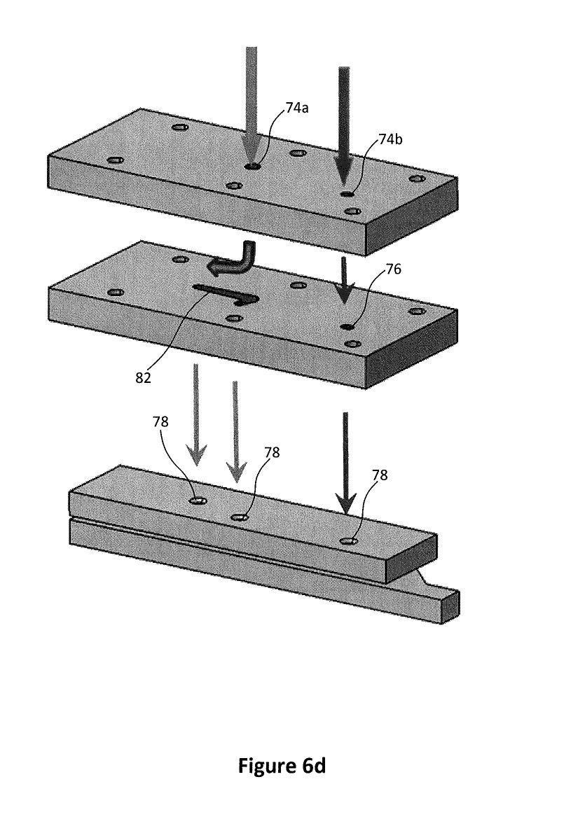

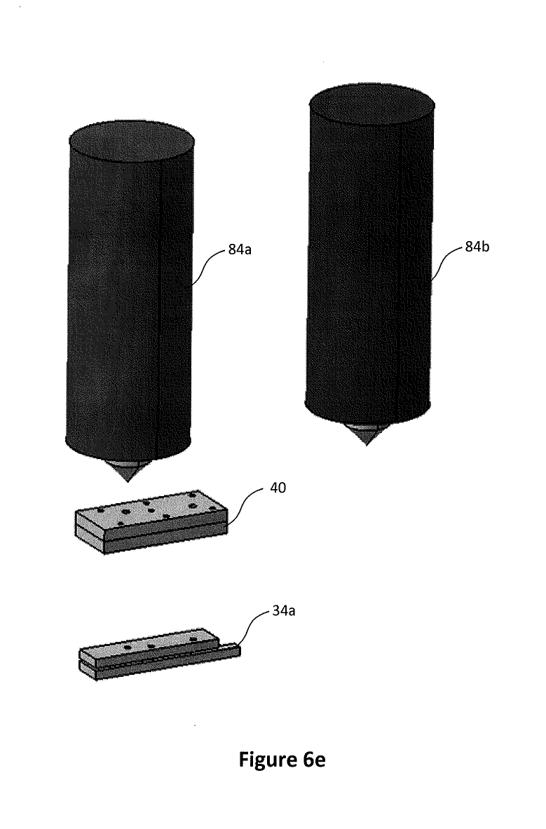

Turning to FIGS. 6a and 6b, schematic diagrams of an intermediate tool are provided. The intermediate tool 40 is used to direct the resin being injected by the resin injector towards the top mould 34a in order to produce the injection moulded part. FIG. 6a is a bottom perspective view of an embodiment of the intermediate tool 40 and top mould 34a and FIG. 6b is a top perspective view of FIG. 6a.

As shown in FIGS. 6a and 6b, the intermediate tool 40 includes a pair of plates 70, seen as a resin receiving layer 70a and a resin distribution layer 70b which are connected together by fasteners (not shown) located within a set of fastening holes 72. In one embodiment, the fasteners are a set of screws.

The intermediate tool 40 further includes a resin receiving holes 74 (within the resin receiving layer 70a) which is connected to the tubing 38 of FIG. 2a. A set of resin distribution holes 76 through which the resin is distributed to the top mould 34a is located within the resin distribution layer 70b. As shown in FIG. 6b, the top mould 34a includes a set of resin holes 78 corresponding with the distribution holes 76 of the intermediate tool 40.

Turning to FIG. 6c, an exploded view of a first embodiment of the intermediate tool is shown. In the embodiment of FIG. 6c, the intermediate tool 40 is used to handle a single coloured resin. As can be seen, the resin distribution layer 70b includes a channel 80 which distributes the resin received from the resin injector through the single resin receiving hole 74. The resin is distributed within the channel (which corresponds with the resin distribution holes 76) such that the resin is then injected into or delivered to the set of resin holes 78 within the top mould 34a.

Turning to FIG. 6d, an exploded view of a second embodiment of the intermediate tool is shown. In the current embodiment, which is to be used with resins of differing colours, a first coloured resin is injected through a first resin receiving hole 74a while a second coloured resin is injected through a second resin receiving hole 74b. As seen in FIG. 6d, the resin distribution layer 70b includes a channel 82 for distributing the first coloured resin such that it can be distributed to the top mould 34a via distribution holes 76 corresponding to the channel 82. For the second coloured resin, the resin is directed at the distribution hole 76 corresponding to the second resin receiving hole 74b. As will be understood, the number of resin receiving holes depends on the number of different colours of resins that are required for the injection moulded part. Furthermore, although only a single channel is shown, the channel design is also dependent on the design of the injection moulded part.

The different colour resins may be injected at the same time (assuming that the first and second resin receiving holes are aligned with resin reservoirs or the different coloured resins may be injected one-by-one. One such embodiment is shown in FIG. 6e.

In FIG. 6e, a pair of resin reservoirs 84 are shown with one reservoir 84a including the first coloured resin and the second reservoir 84b including the second colour resin. Although not shown, the resin reservoirs may be located on a track which may rotate or slide.

In operation, the first coloured resin is injected into the first resin receiving hole and then the second resin reservoir is moved such that it is located above the second resin receiving hole to inject the second coloured resin into the intermediate tool 40. Alignment of the resin reservoirs with respect to the resin receiving holes will be understood by one skilled in the art. Alternatively, the resin reservoirs may stay in place and the intermediate tool (or injection moulding apparatus) moved to align the injection moulding apparatus with the stationary resin reservoirs.

The above-described embodiments are intended to be examples only. Alterations, modifications and variations can be effected to the particular embodiments by those of skill in the art without departing from the scope, which is defined solely by the claims appended hereto.

In the preceding description, for purposes of explanation, numerous details are set forth in order to provide a thorough understanding of the embodiments. However, it will be apparent to one skilled in the art that these specific details may not be required. In other instances, well-known structures may be shown in block diagram form in order not to obscure the understanding. For example, specific details are not provided as to whether elements of the embodiments described herein are implemented as a software routine, hardware circuit, firmware, or a combination thereof.

Embodiments of the disclosure or components thereof can be provided as or represented as a computer program product stored in a machine-readable medium (also referred to as a computer-readable medium, a processor-readable medium, or a computer usable medium having a computer-readable program code embodied therein). The machine-readable medium can be any suitable tangible, non-transitory medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor or controller to perform steps in a method according to an embodiment of the disclosure. Those of ordinary skill in the art will appreciate that other instructions and operations necessary to implement the described implementations can also be stored on the machine-readable medium. The instructions stored on the machine-readable medium can be executed by a processor, controller or other suitable processing device, and can interface with circuitry to perform the described tasks.

The above-described embodiments are intended to be examples only. Alterations, modifications and variations can be effected to the particular embodiments by those of skill in the art without departing from the scope, which is defined solely by the claims appended hereto.

What is claimed is:

1. A method for locally applying an injection moulded part to a primary part comprising:
placing the primary part atop a bottom mould;
sandwiching the primary part between the bottom mould and a top mould, the top and bottom mould defining a cavity within a footprint of the primary part; and
injecting resin into the cavity to locally apply the injection moulded part to the primary part.

2. The method of claim 1 further comprising:
cooling the resin to produce a finished production part; and
removing the finished production part.

3. The method of claim 2 wherein removing the finished production part comprises:
urging the top mould away from the finished production part; and
retrieving the finished production part from the bottom mould.

4. The method of claim 1 wherein placing the primary part atop the bottom mould comprises:
aligning the primary part with the bottom mould.

5. The method of claim 1 wherein injecting resin comprises:
injecting multiple coloured resins into the cavity.

6. The method of claim 5 wherein injecting multiple coloured resins comprises:
injecting a first coloured resin into a first resin receiving hole; and
injecting a second coloured resin into a second resin receiving hole.

6. The method of claim 6 wherein injecting multiple coloured resins further comprises:
distributing the first and second coloured resins to resin receiving holes within the top mould.

8. The method of claim 1 wherein a footprint of the top mould is smaller than the footprint of the primary part.

9. The method of claim 1 wherein a footprint of the bottom mould is smaller than the footprint of the primary part.

10. Apparatus for locally applying an injection moulded part to a primary part comprising:
a support structure;
a resin injector mounted to the frame for injecting resin;
an injection moulding tool including a top mould and a bottom mould, the injection moulding tool including an opening for receiving the resin from the resin injector;
a set of support arms, the support arms connected to the support structure in a hinged relationship for moving the top mould with respect to the bottom mould;
wherein when the top mould and bottom mould define a cavity within a footprint of the primary part when the top mould and bottom mould sandwich the primary part; and
wherein the resin injector injects resin into the cavity to locally apply the injection moulded part with the primary part.

11. The apparatus of claim 10 further comprising:
an intermediate tool for distributing resin from the resin injector to the injection moulding tool.

12. The apparatus of claim 11 wherein the intermediate tool comprises:
a set of resin receiving holes;
a set of resin distribution holes corresponding to top mould resin receiving holes within the top mould of the injection moulding tool; and
a set of channels for directing resin from the set of resin receiving holes to the set of resin distribution holes.

13. The apparatus of claim 10 further comprising a clamping tool for clamping the top mould and the bottom mould against the primary part.

14. The apparatus of claim 10 wherein the top mould comprises a geometry portion.

15. The apparatus of claim 14 wherein the geometry portion includes a lip portion for providing an improved seal between the top mould and the primary part.

16. The apparatus of claim 10 wherein the bottom mould comprises a geometry portion.

17. The apparatus of claim 16 wherein the geometry portion includes a lip portion for providing an improved seal between the bottom mould and the primary part.
